(19) United States
(12) Patent Application Publication
(10) Pub. No.: US 2003/0232107 A1
(43) Pub. Date: Dec. 18, 2003

(54) Biosolids-based food additive and food material for animal food and methods of production and use thereof

(76) Inventors: Seth Sprague Terry, Denver, CO (US); Andrew Joseph Logan, Denver, CO (US)

Correspondence Address: SETH S. TERRY, 379 SOUTH PENNSYLVANIA ST., DENVER, CO, 80209, US

(21) Appl. No.: 10/458,930

(22) Filed: Jun. 11, 2003

Related U.S. Application Data
(60) Provisional application No. 60/388,323, filed on Jun. 13, 2002.

(51) Int. Cl. A01K 1/00

(52) U.S. Cl. 426/2

(57) ABSTRACT

This invention involves a composition for feeding animals, where the composition is produced in a wastewater treatment operation. Waterborne organic materials in the wastewater stream are metabolized by microorganisms resulting in the formation of a biosolids mass comprised of microorganisms. This biosolids mass is then used as a food source for animals. This food material may be further supplemented by adding other components to enhance its nutritional qualities. The wastewater stream containing the waterborne organic materials may be part of, for example, a food processing plant or a microbiologically-based pharmaceutical product manufacturing facility. The invention includes a food material for animals as well as methods of producing this food material and of feeding animals with this food material. The invention further includes the feeding of an organic fertilizer or an organic soil amendment to animals.

### CROSS-REFERENCE TO RELATED APPLICATIONS

This application claims the benefit of PPA Ser. No. 60/388323, filed Jun. 13, 2003 by the present inventors.

### FIELD OF THE INVENTION

This invention relates to the production of animal food material through microbial action on wastewater streams containing organic matter and methods for feeding this food material to animals. The invention also includes compositions for the food material.

### BACKGROUND OF THE INVENTION

Commercial Sources of Food for Fish and Other Animals—Prior Art

Commercial food supplies for animals (e.g., birds, fish, cattle, etc.) consist of nutrients (e.g., protein, vitamins, minerals, fats, and carbohydrates) contained in a form that facilitates delivery to animals. For the purposes of this document, “delivery” or “feeding” to animals is intended to involve the oral ingestion and subsequent internal metabolism of a food material. Currently, food destined for animals such as fish, birds, and other livestock consists of raw ingredients or food additives that may include whole, unprocessed food materials (e.g., meat or plants), marginally processed foods (e.g., fish meal, soy meal, nut meal, etc.), and waste byproducts generated in the production of other food (e.g., wheat middlings, bone meal, blood meal, feather meal, etc.). The marginally processed materials themselves are the products of whole food sources while the by-product materials are generally residuals from food production using whole food sources. When by-product materials are thus utilized in the production of another salable product, the process is commonly referred to as co-production. As an example, fish meal is the product of processed whole food (school fish such as menhaden, anchovies, sardines, etc.) that have been harvested from natural environments while wheat middlings are a co-product food additive with which the fish meal may be amended. Further examples of co-product use include the incorporation of waste hops, barley, and yeast from breweries into food products for cattle, horses, and chickens.

FIG. 1 (prior art) provides a schematic of a food processing operation. Initially, input material comprising food ingredients 1 is introduced to the manufacturing process 2. These ingredients 1 are manipulated (e.g., peeled, cleaned, chopped, cooked, etc.) in the manufacturing process that ultimately results in the production of a finished food product 3. As a result of the manufacturing process, waste is often generated. Such wastes are either solid matter residuals 4 or waterborne residuals 5. Solid matter residuals are often utilized as a beneficial by-product 6. Often these by-products are utilized in the co-production of animal feeds (e.g., yeasts, wheat middlings, potato waste, etc). The waterborne residuals (i.e., dissolved and particulate matter) are generally treated in a wastewater treatment process 7 (see section entitled “Wastewater Treatment, focusing on aspects relevant to the present invention” below and FIG. 2 for an explanation of a typical wastewater treatment process).

In addition to the food materials identified earlier, a variety of other alternative food additives may be employed to provide nutrition to animals. Often, the motivation for employing alternative food additives in feed formulations is to reduce the cost of the protein component. As a result, researchers have examined the use of vegetable products (such as soy) and monocultures (or well characterized mixed communities) of single-cell (i.e., microbial) protein sources as a primary food additive. These microorganisms are grown on substrates including natural gas. Additional organisms that may be incorporated into animal food include algae, yeast, and zooplankton. An extreme example for an alternative animal food is found in some developing-world aquaculture operations where the feces of pigs, ducks, cows, and other animals have been utilized as a feed in order to recover the nutritional value remaining in these waste products. However, the use of such products as a feed may compromise the taste imparted to the meat of the fish that have been fed in this manner. When a number of food additives are combined to produce a food for animals, it is common also to add nutritional amendments, flavor enhancers, dyes, etc. in order to improve the efficacy, quality, or appearance of the food.

Fish meal provides a common source of protein for animal food, particularly in the aquaculture, pig, poultry, and pet food industries. However, concerns abound regarding the use of fish meal as a food additive. Overall, worldwide consumption of fish meal was approximately seven million tons in 2001. The magnitude of this demand for fish meal has led to concerns about depleting wild fish stocks due to over-fishing. These fears are further heightened by seasonal fluctuations and meteorological events (e.g., El Niño, La Niña) that influence market prices for fish meal. An article in a November 2001 issue of Nature raises concerns about decreased landings of wild fish (Watson and Pauley, Nature, vol. 414 (2001), pp. 534-536).

To summarize, raw material inputs for producing animal food draw from various sources, originating directly from the natural environment or deriving from the manufacture of other products, especially other foodstuffs. The incorporation of sufficient protein into the end-product animal food represents a major manufacturing goal, the attainment of which greatly influences the ultimate cost of producing said animal food. Commodities pricing and market availability of protein sources in turn modify the cost of incorporating sufficient protein into manufactured animal food. Increasingly, food producers, particularly in the aquaculture and domestic animal food industries, have utilized fish meal harvested from various natural fisheries. However, this dependence has led to environmental concerns over the depletion of natural resources. Further, for food industries not commonly utilizing fish meal as a protein source (such as the cattle food industry), efforts to incorporate by-product protein sources (such as bone, blood, and meat by-products) in animal food have led to concerns regarding the transfer of protein that may lead to bovine spongiform encephalopathy (aka mad cow disease).

Wastewater Treatment, Focusing on Aspects Relevant to the Present Invention—Prior Art

Generally, wastewater treatment plants exist to remove contaminants from an aqueous wastestream (i.e., a wastewater) prior to ultimate disposal of treated water to a receiving water body (e.g., a river). Wastewater can derive from both industrial processes (such as a food processing facility, where sewage inputs are not necessarily present) and domestic sources (such as a municipality, where sewage inputs are primary contributors to overall flow). Frequently, contaminants present in wastewater include soluble, carbon-containing (i.e., organic) compounds that contribute to chemical oxygen demand (COD). COD is the measure of oxygen-consuming capability of a wastewater and is generally correlated to the amount of waterborne organic material contained in that wastewater. In other words, the greater the organic matter content of a wastewater, the greater will be the COD determined for that wastewater. In order to meet most regulatory standards in the United States, COD should fall below about 45 mg/L prior to discharge to a receiving water body. Influent wastewaters to wastewater treatment plants may vary greatly with regard to their COD concentrations and chemical characteristics. For example, many food-producing facilities generate wastewaters containing COD levels in excess of 45,000 mg/L while wastewater treatment plants processing municipal sewage generally receive waters averaging between approximately 300 mg/L and 600 mg/L. Further, wastewaters may contain COD-contributing compounds present in a wide spectrum of organic forms and molecular weights. In some instances, particularly in the food industry, implementation of wastewater treatment using biological means may prove difficult as the result of nutrient limitations (e.g., nitrogen, phosphate, or some other essential nutritional component present in insufficient concentrations to enable microbial growth).

FIG. 2 (prior art) provides a schematic for a typical wastewater treatment plant using biological means. (For reference, FIG. 2 provides an example set of unit operations for the process represented in box 7 on FIG. 1.) Influent wastewater 8 containing COD is introduced to the treatment process (FIG. 2). Although numerous variations of plant design may be found in practice, the essence of biological wastewater treatment is to contact microorganisms (especially bacteria) with waterborne organic material in the wastewater. Commonly this contact occurs in a basin (or series of basins) 9 in which oxygen is introduced to maintain aerobic conditions. As a result of this contact, the microorganisms metabolize the waterborne residuals contained in the wastewater, thereby utilizing available energy (in the form of reduced carbon compounds) contained therein. In the process of meeting cellular metabolic needs, including maintenance and growth (i.e. cellular replication), residual matter (i.e., COD-contributing compounds) in the wastewater is metabolized and converted into microbial mass. In order to separate treated water from solid cellular material (aka solids), the contents of the aeration basin(s) 9 are subsequently allowed to settle in a clarifier basin 10. A portion of the separated solids is then returned 11 to the aeration basin(s) 9 to maintain a high concentration of organisms therein. In order to maintain steady state conditions, those solids not returned to the aeration basin must be wasted (i.e., removed) 12 from the treatment process. These wasted solids are commonly referred to as waste activated sludge or WAS. Therefore, as a result of biological wastewater treatment processes, the aqueous residuals (i.e., COD-contributing compounds) in the influent wastewater stream are largely incorporated into cellular solids that ultimately must exit the treatment process while the treated water is discharged to a receiving water body 13. Removed cellular solids (i.e., WAS) are collected and disposed of in a variety of ways, most commonly after partially removing the intracellular water (i.e., dewatering) in a dewatering process 14.

FIG. 3 (prior art) outlines one possible strategy for dewatering and disposal of this cellular material. (For reference, FIG. 3 provides an example set of unit operations for the process represented in box 14 on FIG. 2.) In this figure, waste solids 15 are applied to a belt filter press 16 that partially removes the intracellular water contained therein. This method of dewatering is one of several available methods including centrifugation and thermal drying, among others. Upon introduction to the belt press, the solids content in WAS is often less than approximately 3% solids on a percent by weight basis. However, at the completion of belt-press dewatering, the solids content in the resulting filter-cake (comprised of partially dewatered biological solids, aka biosolids) 17 is often between about 15% and about 20% solids. The intracellular water removed during dewatering (i.e., filtrate) is returned to the wastewater treatment process 18. The partially dewatered solids must then undergo a solids disposal process 19. These disposal options are generally costly to the producer of the biosolids material, primarily due to high costs for transportation and tipping. As a result, biosolids producers often undertake efforts designed to decrease the amount of material destined for disposal. Such strategies include aerobic and anaerobic digestion—processes that seek to convert particulate carbon matter (i.e., solids that would otherwise require disposal) to gaseous matter such as carbon dioxide and methane (i.e., volatile components that may be either released directly to the atmosphere or burned, thereby decreasing the amount of solids material requiring disposal).

To expand on available alternatives for the disposal of solids-containing material from wastewater treatment plants (i.e., WAS), one of several strategies may be employed: ocean dumping, incineration, land-filling, and land-application among others. In ocean dumping, WAS (generally in liquid, non-dewatered form) is placed onto a barge (or similar sea-worthy vessel) so as to transport it to a desired location prior to releasing the residual material to the ocean environment. In incineration, WAS is burned to ash in order to reduce the mass of waste to be disposed of, generally by land-filling. Land-filling involves placing WAS (generally partially dewatered) into an appropriate regulated disposal facility in which the WAS is buried. And finally, land-application involves placing the residuals (commonly referred to as biosolids in the context of a beneficial use such as land-application) onto agricultural plots as a means of amending or fertilizing the soil. The first of these strategies (i.e., ocean dumping) requires no dewatering of WAS; however, it is encountering increasing regulatory resistance due to concerns about contamination to the natural environment. Similar concerns have led many wastewater treatment plants to move away from WAS incineration due both to regulatory concerns and to the high energy input required. Land-filling of WAS is also problematic since most facilities will not accept wet matter.

For these reasons, land-application techniques for WAS or biosolids have become increasingly more attractive to operators of wastewater treatment plants. In practice, three types of land-application techniques exist: 1) slurry application, in which WAS is applied directly to cropland or forests, 2) composting, and 3) fertilizer and soil conditioner production. WAS land-application techniques in general, and slurry application in particular, can meet strong community resistance and strict regulatory controls due to concerns over pathogenic organism dispersal. Due to these concerns, composting of biosolids currently represents an attractive ‘beneficial use’ of these waste microorganisms. As a protection against vector transport of pathogens, regulatory requirements of composting processes involve careful monitoring of temperature so as to ensure de-activation (i.e., killing) of the microorganisms comprising the biosolids. As a result of proper implementation of composting procedures, wastewater treatment plants may even be able to generate modest incomes by selling compost material (generally referred to as ‘Class A biosolids;’ see 40 C.F.R. §503). A beneficial use providing an alternative to composting is found in the example of Milorganite® fertilizer and soil conditioner, a product manufactured by the Milwaukee Metropolitan Sewerage District. To generate the product, the manufacturers create dry pellets of biological solids by dewatering (by thermal processes) waste activated sludge removed from their municipal wastewater treatment plant. These pellets are then packaged and sold throughout the United States Finally, U.S. Pat. No. 4,119,495 by Belyaev provides a more extreme example of a potential beneficial use of waste activated sludge microorganisms. In that patent, the inventors present a method for extracting protein from waste activated sludge. However, the process involves costly pH and temperature adjustments in order to recover microbial protein. Other researchers have performed investigations related to utilizing the activated sludge component of domestic wastewater treatment as a foodstuff, but as yet no commercial process for so doing has been implemented (Anwar et al, Aquaculture, vol. 28 (1982) pp. 321-325; Tacon and Ferns, Agriculture and Environment, vol. 4 (1978/1979) pp. 257-269; Tacon and Ferns, Nutrition Reports International, vol. 13 (1976) pp. 549-562; Tacon, Proc. World Symp. On Finfish Nutrition and Fishfeed Technology, Hamburg 20-23 June, 1978, vol. II. Berlin 1979; Edwards, 1992, Reuse of Human Wastes in Aquaculture: A Technical Review, UNDP-World Bank Water and Sanitation Program).

To summarize, removal of COD in wastewaters often relies upon contacting wastewaters with a microbial community, commonly referred to as activated sludge. The organisms comprising the activated sludge community derive energy by scavenging organic constituents found in the wastewater, thereby removing COD from the bulk liquid. This energy drives cellular metabolic processes within these organisms and ultimately results in their growth and proliferation. In order to maintain a steady state process, operators of wastewater treatment facilities must necessarily dispose of significant quantities of cellular mass, commonly referred to as waste activated sludge. Often, this waste activated sludge requires further processing in order to produce a material that may be disposed of in a land-fill or sold as a beneficial use product commonly referred to as biosolids. However, the sale of biosolids products often fails to generate appreciable revenue and thus merely mitigates dewatering and processing costs. Further, the land application of waste activated sludge biosolids does encounter community resistance in some locations. Most of these complaints center about the odor associated with the further biological breakdown of proteins and lipids contained in the biosolids.

### SUMMARY OF THE INVENTION

Conscious of the manner in which the relatively high expenses associated with wastewater treatment preclude its implementation in many parts of the developing world, the inventors of the present invention began to explore options for mitigating these costs. This effort developed into a desire to coordinate wastewater treatment with aquaculture operations in order to take advantage of the high-quality water achieved as the result of biological treatment. However, this desire exposed the potential difficulties found in delivering large quantities of high-quality fish food to operations in potentially impoverished regions. In a short time, the inventors began focusing their attention on the other main product of a wastewater treatment plant: the biosolids. Out of this attention grew an awareness regarding the high nutritional quality of dewatered biosolids generated during wastewater treatment. This discovery prompted a research effort to validate the concept of providing nutrition to higher-order organisms by utilizing these biosolids. For this effort, fish were cultured from fingerling size and maintained for a period of 15 months. During this time, the fish were housed in standard glass aquariums and met their entire nutritional requirement from a slightly amended formulation of dried biosolids generated during wastewater treatment. Control tanks were established in which other fish were fed a commercially available food. The growth of the fish that were fed these dried biosolids compared favorably to the growth of those fish that were fed commercially available food.

The present invention utilizes a product of wastewater treatment (i.e., biosolids commonly viewed as a residual in wastewater treatment processes) in a non-conventional manner. Specifically, these biosolids are used to produce feed formulations to provide a variety of necessary nutritional requirements to fish and other animals. Food processing and manufacturing facilities as well as municipal wastewater treatment plants generate large quantities of biosolids (i.e., in waste activated sludge) during the course of wastewater treatment. The present invention utilizes the beneficial characteristics of this biosolids material, namely its high protein content combined with adequate levels of carbohydrates, vitamins, and nutrients, as the primary matrix or food additive in animal food formulations. The goal of these food formulations is to meet protein and nutritional demands for a variety of domesticated animals. The food material utilized in this invention is distinct from other co-product food materials in that it is derived from waterborne material present in a wastewater stream. Whereas the production of the solids resulting from the removal of this soluble matter has heretofore constituted a disposal issue for wastewater treatment plants, implementation of the instant invention enables operators of appropriate biosolids-producing facilities (including pharmaceutical manufacturing operations) to make a useful and valuable end-product. Further, it enables food producers to manufacture animal food at costs considerably lower than those utilizing traditional raw material inputs. This invention includes the novel food material for animals, the methods of producing this food material, and novel methods of providing a food material to animals. Also included in this invention is the use of biosolids material generated in the microbial production of pharmaceutical products as a source material for animal food.

### Definitions

The following terms and definitions explain how these words are to be used and interpreted throughout the present specification, including in claims.

Animal—any member of the biological kingdom Animalia.

Biological solids, also referred to as biosolids—particulate material generated during wastewater treatment that is biological in nature and that consists mainly of microorganisms but may possibly contain other, macrobiotic organisms.

Feeding—the oral ingestion and subsequent internal metabolism of a food material.

Food—any material providing nutritional benefits, including the ability to grow, to an organism as a result of its oral ingestion.

Microbial cell mass—an aggregate of cellular material comprised of microorganisms and produced as a function of growth or proliferation of those microorganisms.

Microorganism—an organism of microscopic and generally unicellular size.

Nonviable, also referred to as deactivated or inactivated—characteristic of organisms that are killed, unable to reproduce, or stressed to the point of being unable to survive.

Organism—any member of the biological domains Prokarya, Eukarya, or Archaea.

Wastewater—an aqueous stream containing residuals and which is generally considered to be waste requiring treatment prior to ultimate discharge to a receiving water body. In the context of the present invention, the residuals comprise either suspended or dissolved organic matter.

Percent by weight—the weight of a constituent divided by the total weight of sample; this fraction is then be multiplied by 100 in order to express the value as a percentage by weight. Unless otherwise stated, all percentages used in the context of the present invention are intended as percent by weight percentages.

### OBJECTS AND ADVANTAGES OF THE INVENTION

In accordance with the above-presented summary of the invention, and a further description of the invention that will follow, it is the primary object of this invention to provide an animal food source from organic materials in a wastewater stream.

It is a further object of this invention to incorporate organic matter from a wastewater stream into biosolids and to use these biosolids as a food source for animals.

It is a further object of this invention to use an organic fertilizer as a food source for feeding animals.

It is a further object of this invention to use an organic soil conditioning material as a food source for feeding animals.

It is a further object of this invention to use a material that is often considered to be a waste material as a valuable food source for animals.

It is a still further object of this invention to ameliorate an environmental disposal problem by converting material generated from a waste stream into a food source for animals.

It is a further object of this invention to convert materials in a waste stream to a food source for animals where the animals will ultimately provide food for human consumption.

It is a further object of this invention to increase the economic value of waste activated sludge by using it as a valuable food source for animals.

Another object of this invention is to mitigate the costs of operating a wastewater treatment plant by utilizing a current waste material as a raw material for producing animal food.

Another object of this invention is to produce a high quality animal food at a cost considerably less than current animal food.

Another object of this invention is to provide environmental benefits by reducing the amount of waste residuals in wastewater treatment.

Another object of this invention is to provide environmental benefits by decreasing the demand for harvesting protein sources from the wild.

### BRIEF DESCRIPTION OF THE DRAWINGS

List of figures:

FIG. 1: Schematic of a typical food producing operation as found in the prior art.

FIG. 2: Schematic of a typical wastewater treatment operation as found in the prior art.

FIG. 3: Schematic of a typical solids dewatering process for a wastewater treatment plant as found in the prior art.

FIG. 4: Example schematic of materials-flow in the present invention.

FIG. 5: Schematic of extruder employed in research effort involving the present invention.

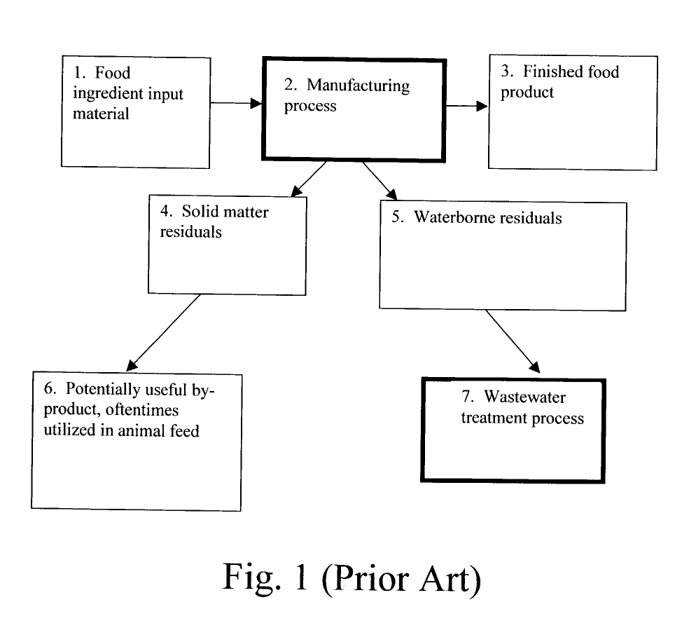

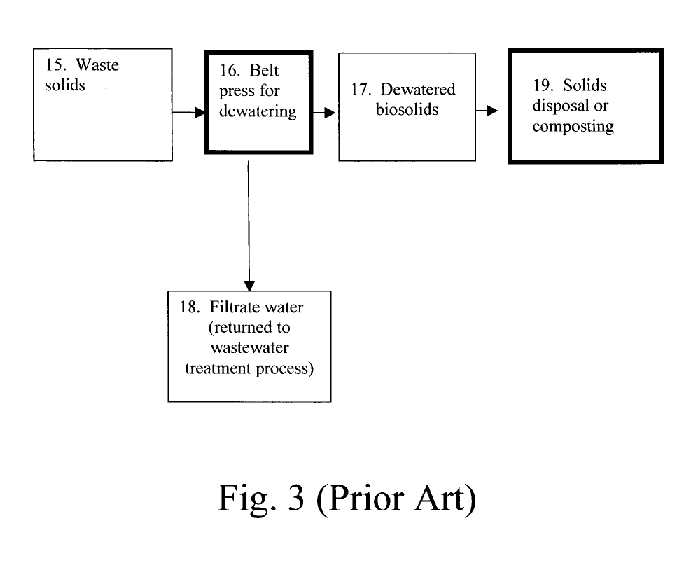

For the schematics represented in FIGS. 1 through 4, thin-walled boxes have been used to indicate materials while thick-walled boxes have been used to indicate processes.

### DETAILED DESCRIPTION OF THE PREFERRED EMBODIMENT

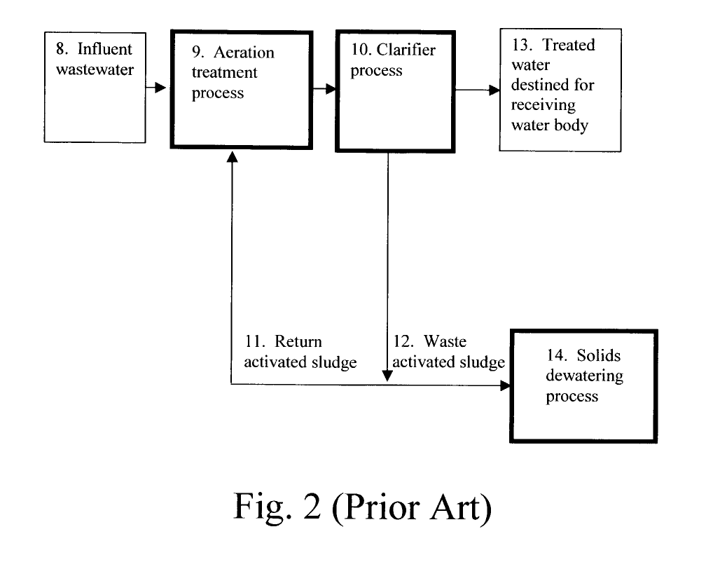

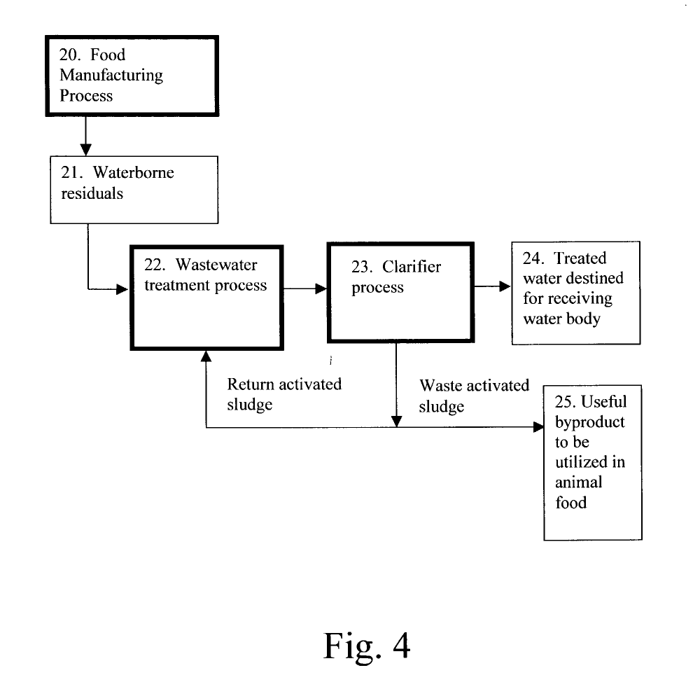

The present invention involves the incorporation of biosolids into a food material. In other words, the raw material for the ultimate food product is microbial cell mass generated either during the treatment of wastewater or the production of pharmaceutical products by microbial means. FIG. 4 illustrates the manner in which the raw material of the present invention is generated. (For reference, boxes 20 and 22 on this figure correspond to the processes represented in boxes 2 and 7, respectively on FIG. 1. In a similar manner, box 23 corresponds to the process represented in box 10 on FIG. 2.) Wastewater emanating from a food manufacturing process 20 and containing waterborne residuals 21 flows into a biological wastewater treatment process 22. The wastewater treatment process 22 generally contains an aeration basin (or more likely a series of basins) in which the residuals (i.e., waterborne, COD-containing material) are contacted with microorganisms (commonly present at less than about 1% solids). In the process of biological wastewater treatment, microorganisms present in the process proliferate, growing on the organic substrate (i.e., waterborne, COD-containing material) supplied in the wastewater. In order to separate treated water from the microorganisms, the mixed liquor suspended solids from the aeration basin(s) of the wastewater treatment process 22 are settled by gravity in a clarifier 23. The overflow from the clarifier is then discharged to a receiving water body 24 while the underflow (containing the bulk of the microorganisms originally found in the mixed liquor suspended solids-generally dewatered to between approximately about 1% and about 3% solids) is split into two streams. The first of these streams is returned to the wastewater treatment process in order to maintain an adequate concentration of microorganisms in the process. This first stream is commonly referred to as return activated sludge. The second of these streams (commonly referred to as waste activated sludge or WAS) then provides the material for animal food 25. More specifically, the cellular mass (i.e., biosolids) comprising the particulate component of the WAS is the nutritional material harvested from the wastewater treatment process and made into food for animals. It is important to note that, in the present invention, prior to being charged to the fluid stream (i.e., to the wastewater), the eventual residual material 21 in the food manufacturing process 20 is treated in an identical hygienic manner to the material that ultimately ends up as a traditional food product (i.e., box 3 on FIG. 1). Where normally no need would exist to maintain hygienic handling of this wastestream, in the present invention, hygienic conditions are maintained (i.e., for all material and processes represented by boxes 21, 22, 23, and 25) as a means of generating an ultimate food product. For example, in order to protect the hygiene of the fluid stream, an industrial food processor utilizing the present invention would avoid disposing of heavy organics (i.e., degreasers and cleaners), toxic chemicals (including metals), or sewage into the same fluid stream. As a result, the food processor would treat the fluid stream with at least the same level of care as other by-product streams destined for animal consumption (i.e., the material represented by box 6 on FIG. 1).

In order to accomplish the goal of processing the WAS stream into a food product, waste organisms (contained in the waste activated sludge) are further dewatered. Most often, a belt filter press provides for efficient, partial dewatering of the solid material. However, a centrifuge or other means (such as thermal drying) also accomplishes this task. Following treatment on a belt press, the solids component of the microbe-containing material (e.g., biosolids in the filter-cake) rises, generally to between about 15% and about 20% solids. Alternative dewatering techniques such as thermal drying can achieve water removal so as to attain solids content in excess of 90%. It is important to note that as a practical matter, it is difficult to remove all (i.e., 100%) water present in a material such as biosolids. Therefore, terms such as ‘wet’ and ‘dry’ are relative terms.

Next, the resulting material is converted into a form suitable for an actual animal feed (e.g., a pellet). This process involves both the drying of the material and the deactivation of the microorganisms present in that material. For a belt-pressed material, this conversion involves an extrusion process as a means of preparing the material for further dewatering. In the extrusion process, the material (containing approximately 15% solids) is pressurized and passed through orifices in order to produce multiple elongated strands, each with a uniform cross-section. The material of uniform cross-section thus attained is then dried further, typically by maintaining a temperature of 105° C. The uniform cross-section of this material allows for even drying and distribution of heat. As a result, organisms present in the extruded material are deactivated. Deactivation of organisms is the process by which viable organisms are rendered harmless by making the organisms nonviable. In a manner similar to the inability of achieving 100% water removal for biosolids (described above), practical limitations exist to achieving 100% deactivation of all microorganisms present in a microbial cell mass. Therefore, an ‘inactivated’ cell mass is one in which the level of inactivation is sufficient to produce a safe food material for the animals destined to utilize this material as a food.

At the completion of this drying and inactivation (aka deactivation) procedure, material that was extruded but not cut prior to drying requires further processing so as to be made suitable for feeding to animals. Specifically, in the case of a material dried into a sheet-like structure, grinding or crushing serves to attain the desired pellet size corresponding to the animal for which the food is intended. For example, fish and cattle generally prefer pellets of approximately ¼-inch diameter while chickens generally prefer a coarse scratch material. A subsequent screening step removes fines from the end-product when such fines are considered problematic (e.g., in an aquaculture operation where fines compromise water quality).

Ultimately, the material generated by the above process is used by feeding it to animals utilizing conventional methods (e.g., spreaders, troughs, etc.). As stated before, “feeding” to animals is intended to involve the oral ingestion and subsequent internal metabolism of a food material. The intent in feeding this material to animals is to meet daily metabolic needs, including growth and maintenance, and eventually to produce harvestable organisms (i.e., macro-scale organisms such as fish or other livestock) for human or animal consumption. The biosolids food can be fed to organisms including mammals, birds, and fish. Regarding the latter organism, biosolids food can be fed to fish in the biological class Osteichthyes such as (but not limited to) any of the following: tilapia, milkfish, bass, sturgeon, catfish, salmon, tuna, perch, bluegill, bream, walleye, trout, and carp.

Other modifications to the above-described process fall within the scope of this invention. Some of these modifications are now presented. Such modifications or improvements can be implemented as a means of i) controlling the type of organisms found in the WAS, ii) increasing the quantity of the organisms produced during wastewater treatment, iii) improving the quality of the food produced from biosolids harvested from WAS, or iv) increasing the commercial and economic success of the food produced from harvested biosolids.

For example, one can control the manner in which the wastewater treatment plant is inoculated. Generally, current practice for wastewater treatment plant start-up involves transporting solids from an existing treatment plant. These solids may have been in contact with municipal sewage. As a means towards producing a commercially successful end-product, it is beneficial to avoid contacting microorganisms destined for food with municipal sewage. Therefore, an alternative process, avoiding biosolids contact with municipal sewage, is offered in the following paragraph.

In this alternative process, various bacteria appearing on the list of food additives approved for direct feeding to humans compiled by the United States Food and Drug Administration (Association of American Feed Control Officials, 2001 Official Publication) are emplaced into an appropriate fermentor, such as a chemostat, a sequencing batch reactor, or a similar apparatus. One or more of these microorganisms is added to the fermentor. The final concentration of bacteria in the fermentor's mixed liquor suspended solids preferably should fall between approximately 2500 mg/L and 5000 mg/L, or some other concentration that allows for ready settling of the bacterial flocs. The fermentor includes provisions for mixing the culture of microorganisms, introducing substrate-containing water, maintaining appropriate redox conditions, and decanting water following the settling of bacterial flocs. The substrate-containing influent to the fermentor is actual process-water, containing waterborne COD-contributing residuals from a food processing operation. The decanted water from the fermentor is depleted of this COD, having provided energy and substrate to meet the growth and maintenance needs of the bacterial culture. During the growth of the culture, parameters such as total suspended solids, volatile suspended solids, fixed suspended solids, and sludge volume index is determined as a means of monitoring growth and settling properties of the culture. At various stages in the development of this culture, bacterial growth requires moving the bacteria from a fermentor of a given size to an incrementally larger apparatus to accommodate the increasing number of microorganisms. This task must always provide for maintaining an appropriate sludge volume index in the mixed liquor suspended solids of a fully charged reactor, generally between about 100 L/kg and about 300 L/kg. The ultimate goal of this culturing procedure is to create a controlled community of innocuous microorganisms that constitute the activated sludge component of an industrial-scale process-water treatment plant. The waste activated sludge from this plant, in either liquid or filter-cake form can be utilized to inoculate future treatment plants using this community of microorganisms.

Also related to the ecological make-up of the microorganisms comprising the food matrix, pure cultures can provide the source of nutrition. For example, significant amounts of filter-cake are produced in pharmaceutical production utilizing fermentative processes. As a result of the tight controls on the production of pharmaceutical products, the filter-cake emanating from such operations comprises homogeneous populations (generally monocultures) of single-cell organisms. Such well characterized populations offer an excellent opportunity for producing microbial food products consisting of a controlled community (or even a single species) of microorganism(s) as opposed to uncontrolled, mixed populations.

Another embodiment of this invention requires avoiding a common-practice technique for handling microorganisms during the process of wastewater treatment. Specifically, in order to produce higher quality biosolids destined for animal food, it is necessary to bypass digestion of WAS prior to dewatering of the biosolids. An example provides an illustration of the deleterious effects of digestion with respect to the food quality of biosolids. It has been observed that dried biosolids removed following belt-pressing often possess ash percentages in excess of 35%. Since ash represents refractory material (generally inorganic in nature) that cannot be fully utilized by animals, it is desirable to mitigate ash production by implementing appropriate operating conditions in the wastewater treatment plant. In current operating procedures, biosolids production is viewed somewhat as a liability since such material must be disposed of as waste or further treated in order to produce a commercial product of relatively low value (e.g., compost material). As a result, WAS is customarily digested (i.e., retained in facility tanks for days or weeks under either aerobic or anaerobic conditions) as a means of converting some fraction of the solids mass to carbon dioxide gas and soluble metabolites, thereby removing organic mass from the WAS. From the standpoint of waste minimization, this digestion process enables the treatment facility to reduce its volume of biosolids destined for disposal, and thereby to reduce its costs for disposal. In the process, relatively easily digested molecules (such as protein and lipids) are metabolized while more refractory molecules and inorganics remain in the digested WAS. With increasing digestion, the WAS attains an increasingly high percentage of ash (i.e., refractory or inorganic matter). Conversely, under operating procedures that consider biosolids to be a valuable, harvestable product rather than a disposable material, it is beneficial to avoid digestion of the WAS as a means of mitigating ash production. As an added benefit of bypassing WAS digestion, the content of protein and lipids in the WAS also increases, thereby adding to the nutritional value of the biosolids. Specifically, avoidance of digestion results in a lowered retention time of biosolids in the wastewater treatment facility; this lowered retention time corresponds to a lower sludge age (i.e., average length of time a microbial cell remains in the treatment process) that in turn corresponds to an increased level of crude protein in these biosolids. For example, involving waste activated sludge, a dried filter-cake biosolids sample that included digested solids had a protein content of approximately 33% whereas a similar sample removed prior to digestion (and having a ‘young’ sludge age of approximately 5 days) yielded protein content of more than 50%—a value approaching the 60% generally considered a practical upper limit for protein levels in bacteria (Niedhardt et al, Physiology of the Bacterial Cell: A Molecular Approach. 1990 Sunderland, Mass.; Gottschalk, Bacterial Metabolism, 2nd edition, 1986, Springer-Verlag).

Where analysis of individual raw material filter-cake (i.e., biosolids) exposes deficiencies in necessary nutrients such as specific vitamins or minerals, these necessary nutrients are incorporated into the manufacturing process. More specifically, the food material described above can be supplemented by adding other components such as (but not limited to) any of the following: lipids, carbohydrates, vitamins, minerals, and fiber. Additionally, these components could be supplied to animals without being mixed in with the biosolids. Similarly, in order to customize the ultimate food produced to the target animal for which it is destined, other ‘bulking’ materials (e.g., wheat middlings, potato shavings, etc.) are added to the biosolids so as to improve structural properties or digestibility. Further, the addition of color-or taste-imparting components (e.g., dyes, fish oil, or herbal extracts) provides a means of improving the commercial quality of the meat grown from the biosolids food. These materials are added in a manner similar to that described for the addition of lipids (see Examples below). In addition to using biosolids material directly or as supplemented (as described above), this biosolids material can also be mixed with other animal foods to produce the food material ultimately fed to animals. In other words, the biosolids food material can be amended with other components in much the same manner as materials such as fish meal are used today.

The preferred embodiment (presented at the beginning of this section) and examples given below describe the production of extruded pellets of the food material of the present invention. The pellets produced by the process described below are relatively dense (i.e., possess a specific gravity greater than 1) and therefore sink in water. Alternative processes for producing animal food include manufacturing floating pellets (i.e., pellets that possess a specific gravity less than 1) as well as flake, chip, granular, powder, paste, or slurry forms. For example, belt-pressed biosolids material, already possessing a very thin and uniform appearance, produce a chip-like dried material when conveyed directly into an appropriate drying process. In another embodiment, initial dewatering in a belt press or similar device is bypassed altogether. In this approach, WAS passes under high pressure through a nozzle into an evaporative chamber or high speed cyclone, thereby producing a powder or pellets.

Finally, the preferred embodiment, and examples given below, utilize one possible procedure for drying biosolids and deactivating the organisms therein. In order to produce a commercial product, the practices described in the preferred embodiment (and Examples given below) for drying the pressed biosolids could be altered so as to ensure minimal degradation to the quality or availability of nutrients (especially protein) in the biosolids. Since one of the purposes in drying and heating the biosolids is to deactivate organisms, any such alteration to the drying procedure needs simultaneously to provide sufficient deactivation of the organisms contained in the biosolids to produce a safe food product. To avoid the potential negative aspects associated with thermal deactivation, other means for killing these microorganisms can be employed or combined with lower temperature thermal deactivation. Such alternative deactivation procedures include the application of radiation (e.g., alpha rays, beta rays, gamma rays, x rays, ultraviolet, microwave, and radiowave), autoclaving, or physical disruption utilizing a French press (a mechanical device utilized to shear cell membranes by passing a cellular slurry through a small orifice under high pressure).

### EXAMPLE 1

### Producing the Food Material of the Present Invention

This is a specific example of how the animal food of the present invention was produced. Analyses of a biosolids filter-cake dried to constant mass in an oven at 105° C. following its removal from a wastewater treatment plant serving a beverage producer demonstrated that this material contained approximately 33.5% crude protein, 4.5% crude fiber, 1.5% lipids, and 36.0% ash. The balance of the material (i.e., approximately 24.5%) was presumed to be carbohydrates. At the beginning of the experiment, this filter-cake was a mix of biosolids from dewatered WAS generated from two separate treatment plants: 1) a pure oxygen process used to treat waste from beverage production and 2) a conventional system in which ambient air provided oxygen to treat sewage from a municipality. During the course of the experiment, the treatment scheme employed was reconfigured to include anaerobic digestion of beverage waste prior to entry of the fluid stream to the pure oxygen process. Throughout the course of experimentation, a portion of the WAS was digested aerobically prior to passing through the belt press. Following belt-pressing, dewatered biosolids (at approximately 15% solids content) not utilized in this experiment were sent to a composting facility for further processing prior to ultimate sale as a soil amendment.

As stated above, the lipids content of the belt-pressed biosolids was measured at 1.5%. However, food requirements for tilapia (i.e., the species of fish chosen to implement this experiment) generally prescribe 6% lipids content. As a result, producing an experimental food for these organisms from the biosolids filter-cake required the addition of approximately 4.5% lipids content. This addition was accomplished using a food-grade mixture of canola and soybean oils (Crisco® pure vegetable oil manufactured by Proctor and Gamble), assumed to contain 100% lipid content based upon the nutritional information provided. This material was added directly to the filter-cake and mixed by hand in a small tub. More specifically, 12 g of vegetable oil was added to a container determined to contain 1.8 kg of freshly obtained wet filter-cake. Earlier determinations indicated that this wet filter-cake generally contained approximately 15% solids. As a result, the 12 g of added vegetable oil represented approximately 4.5% of the 265 grams (dry-weight) biosolids expected in the 1.8 kg of filter-cake.

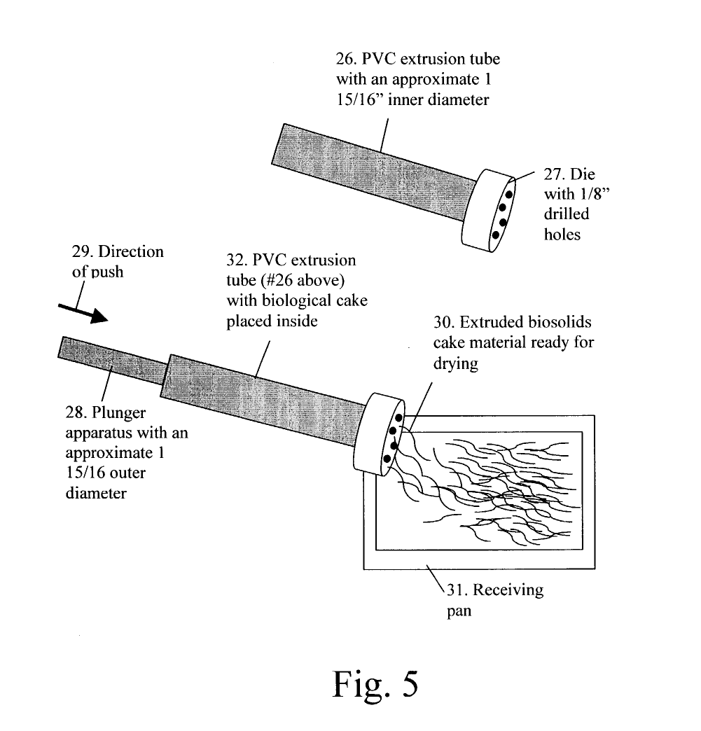

In order to dry the filter-cake effectively as well as to produce pellets of an appropriate diameter, amended filter-cake was passed through an extruder. A drawing incorporating the important elements of this extruder is provided in FIG. 5. The extruder was assembled from two pieces of PVC pipe of differing diameters. Following amendment with lipids, the biosolids were introduced into the larger diameter tube 26. This tube contained a cap 27 at the end opposite to that into which the biosolids were introduced. Multiple holes of approximately □-inch diameter were drilled into this cap. Following introduction of the biosolids material to the large diameter tube, a smaller diameter tube 28 with a plug at one end (i.e., a plunger) was used to push 29 material through the □-inch diameter holes. The material of uniform cross-section thus obtained 30 was then collected in a receiving pan 31 and dried overnight at 105° C. The uniform cross-section of this material allowed for even drying. Further, the heat delivered to the material in the drying process served to deactivate (i.e., to kill) the microorganisms in the material. Following this drying process, samples of the material were analyzed for total heterotrophs using common plate and agar techniques. For these analyses, trypticase soy agar was prepared at both 100% and 5% nutrient strength and poured into petri plates. Samples of the dried cake material (approximately 2 g) were removed from the 105° C. oven, placed in 5 ml of sterilized phosphate buffer and crushed using a sterilized glass stirring rod. Next, 0.5 ml samples of the resulting suspension were spread on both agar plate types and were then incubated at 30° C. overnight. These plate counts yielded no viable bacterial colonies.

Following complete drying (generally overnight for the purposes of conducting the experiment), the dried material (possessing a speghetti-like mesh structure conforming to the size of the receiving pan) was ground to produce pellets suitable for feeding to fish. Specifically, for the purposes of feeding tilapia of approximately 200 g, □-inch diameter pellets ranging in length between □-inch and ¼-inch are most appropriate. Generally, the processing of 1 kg of wet filter-cake yields approximately 150 g of the amended food product. Several assumptions common to the wastewater industry may be employed to lend a sense of scale to the production of food from wastewater residuals in the manner prescribed by this invention. Specifically, a typical range for cell yield (in units of grams of dry-weight cells formed per grams of COD removed from the wastewater) is between 0.4 and 0.6. Therefore, utilizing an average value for cell yield of 0.5, the 150 g of dry-weight food product derived from approximately 300 g COD removed from wastewater.

### EXAMPLE 2

### Feeding Fish with the Food Material of the Present Invention

This example shows how the animal food of the present invention was fed to fish and demonstrates the efficacy of this animal food. For testing purposes, Tilapia niloticus was selected as the experimental animal. These fish were maintained in a 55-gallon tank. Originally, the tank contained seven fingerlings of approximately 30 g each. However, as the fish grew, four of these fish were removed from the tank and archived as samples so as to prevent over-crowding of the remaining fish. Eventually, following 15 months of study, three fish of approximately 250 g each remained in the tank. Tank temperature was maintained at 30° C. using a standard aquarium heater. Ambient air was delivered into the tank using a diffusion stone so as to maintain dissolved oxygen levels in excess of about 2 mg/L. Water from the tank was filtered at a rate of approximately five tank volumes per day through a shrouded downflow trickling filter apparatus equipped with a polishing basin screened by granular activated carbon contained in a nylon mesh. The food product generated by the processes described in Example 1 was hand-delivered (utilizing a plastic scoop) to the fish at a rate of approximately 7 mg food per gram of fish per day. Over-feeding was avoided by examining the aquarium bottom for evidence of uneaten food. The fish were examined for signs of under-feeding by checking them for evidence of cannibalism; no such evidence of cannibalism was observed. During the course of the experiment, no attempt was made to maximize the growth of the fish involved in the study. To the contrary, due to space limitations, fish were generally fed at rates far below those utilized in commercial fisheries where the goal is to maximize the rate of growth. As a result, the fish observed in this study were fed only once per day during the standard five-day workweek and infrequently on weekends. Nevertheless, in the course of 15 months, the fish studied had grown from fingerlings of approximately 30 g to fish of approximately 250 g. During this period, measured average growth rates were approximately 15 g/month.

A control experiment utilizing commercial tilapia food was conducted simultaneously to the above experiment utilizing the developed biosolids-based food of the present invention. This experiment involved fingerlings from the same stock of tilapia as used in the experiment using the biosolids-based food of the present invention. The fish were reared in similar tanks, controlled in a nearly identical manner with respect to water temperature, filtration, and levels of dissolved oxygen. However, rather than being fed food generated from microbial biosolids, the fish in the control experiment were fed on a commercial, floating tilapia feed from Nelson's Silver CUP™, a company based in Murray, Utah. The results of this control experiment showed that the fingerling tilapia (of approximately 30 g each) grew to nearly 240 g over 15.5 months. In other words, the measured average growth rate for the control fish was just over 13 g/month. Just as for the biosolids-based food experiment, no attempt was made to maximize the rate of growth for the control fish.

The instant invention is presented and described in what are considered to be the most practical and preferred embodiments. It is recognized, however, that departures may be made therefrom that are within the scope of this invention, and that obvious modifications will occur to one skilled in the art upon reading this disclosure.

We claim:

1. A method of feeding animals comprising:
delivering a food containing deactivated organisms derived from constituents in wastewater to said animals wherein said organisms are in the form of a concentrated biosolids mass.

2. The method of feeding animals as described in claim 1 wherein said organisms comprise microorganisms.

3. The method of feeding animals as described in claim 1 wherein said animals comprise at least one of fish, birds, and mammals.

4. The method of feeding animals as described in claim 3 wherein said fish comprise at least one of tilapia, milkfish, bass, sturgeon, catfish, salmon, tuna, perch, bluegill, bream, walleye, trout, and carp.

5. The method of feeding animals as described in claim 3 wherein said fish comprise members of the biological class Osteichthyes.

6. The method of feeding animals as described in claim 1 wherein said animals comprise a fish suitable for consumption by humans.

7. The method of feeding animals as described in claim 1 wherein said food has a protein content in an amount sufficient to support growth of said animals.

8. The method of feeding animals as described in claim 1 wherein said food provides nutritional requirements in an effective amount to support growth of said animals.

9. The method of feeding animals as described in claim 1 wherein said food is supplemented by adding a dietary component selected from the group consisting of proteins, lipids, carbohydrates, vitamins, minerals, and fiber.

10. The method of feeding animals as described in claim 1 wherein said biosolids mass comprises water, and further comprising: removing said water, at least in part, from said biosolids mass to produce said food.

11. The method of feeding animals as described in claim 10 wherein said biosolids mass is in a form selected from the group consisting of granular form, pelletized form, and powdered form.

12. The method of feeding animals as described in claim 1 wherein said wastewater is an industrial wastewater.

13. The method of feeding animals as described in claim 12 wherein said industrial wastewater has been handled with a degree of hygiene appropriate to a material destined for use as an animal food.

14. A method of feeding animals a food comprising:
concentrating dilute waterborne material into a wet microbial cell mass through
mediation of microorganisms;
harvesting said microbial cell mass as a food source;
deactivating said microbial cell mass; and, supplying said microbial cell mass as food to animals.

15. The method of feeding animals as described in claim 14 wherein said microbial cell mass contains water and further comprising:
removing said water, at least in part, from said microbial cell mass prior to providing said food source to animals.

16. The method of feeding animals as described in claim 15 wherein said cell mass is present in an amount at least as great as about 1 percent by weight in said wet microbial cell mass.

17. The method of feeding animals as described in claim 15 wherein said cell mass is present in an amount at least as great as about 10 percent by weight in said wet microbial cell mass.

18. The method of feeding animals as described in claim 15 wherein said cell mass is present in an amount at least as great as about 20 percent by weight in said wet microbial cell mass.

19. The method of feeding animals as described in claim 15 wherein said cell mass is present in an amount at least as great as about 90 percent by weight in said wet microbial cell mass.

20. A method of feeding animals comprising:
delivering a fertilizer derived from wastewater treatment to said animals as a food.

21. The method of feeding animals as described in claim 20 wherein said fertilizer is produced by:
contacting a wastewater stream containing organic matter with microorganisms;
allowing said microorganisms to metabolize said organic matter to produce a fertilizer in the form of a microbial cell mass;
deactivating said microbial cell mass, and,
providing said fertilizer to animals as food.

22. The method of feeding animals as described in claim 21 wherein said fertilizer is treated so as to minimize its ash content and to maximize its nutritional value to animals.

23. The method of feeding animals as described in claim 22 wherein said fertilizer comprises a Class A biosolids material.

24. A method of feeding animals comprising:
delivering a soil conditioner derived from wastewater treatment to said animals as a food.

25. The method of feeding animals as described in claim 24 wherein said soil conditioner is produced by:
contacting a wastewater stream containing organic matter with microorganisms;
allowing said microorganisms to metabolize said organic matter to produce a soil conditioner;
said soil conditioner comprising a microbial cell mass;
deactivating said microbial cell mass; and,
providing said soil conditioner to animals as food.

26. A method of producing a food for feeding animals comprising:
contacting a wastewater stream containing organic matter with microorganisms;
allowing said microorganisms to metabolize said organic matter to produce a microbial cell mass;
deactivating said microbial cell mass; and,
adding a dietary component selected from the group consisting of proteins, lipids, carbohydrates, vitamins, minerals, and fiber to said cell mass to produce an amended food.

27. The method of producing a food for feeding animals as described in claim 26 wherein said amended food has a nutritional composition suitable for the growth of animals that are fed on said amended food.

28. The method of producing a food for feeding animals as described in claim 26 wherein said lipids are selected from the group consisting of plant oil and animal oil.

29. The method of producing a food for feeding animals as described in claim 26 wherein said wastewater is an industrial wastewater.

30. The method of producing a food for feeding animals as described in claim 29 wherein said industrial wastewater has been handled with a degree of hygiene appropriate to a material destined for use as an animal food.

31. A method of producing a food for feeding animals comprising:
contacting a wastewater stream containing organic matter with microorganisms;
allowing said microorganisms to metabolize said organic matter to produce a microbial cell mass;
deactivating said microbial cell mass;
removing water, at least in part, from said cell mass to produce a solid food material that has a specific gravity less than 1 whereby said food floats on water when used for feeding fish.

32. The method of producing a food for feeding animals as described in claim 31 wherein said deactivating involves a procedure selected from the group consisting of thermal deactivation, radiation deactivation, and French-press deactivation.

33. A method of producing a food for feeding animals consisting of:
contacting a wastewater stream containing organic matter with microorganisms;
allowing said microorganisms to metabolize said organic matter to produce a microbial cell mass having a protein content;
preventing said protein content decreasing to a level below about 20%;
harvesting said microbial cell mass;
deactivating said microbial cell mass, whereby the protein content of said food is maintained above said about 20% by minimizing digestion of said microbial cell mass.

34. The method of producing a food for feeding animals as described in claim 33 wherein the protein content of said cell mass is maintained above about 30 percent by weight.

35. The method of producing a food for feeding animals as described in claim 33 wherein the protein content of said cell mass is maintained above about 40 percent by weight.

36. The method of producing a food for feeding animals as described in claim 33 wherein the protein content of said cell mass is maintained above about 50 percent by weight

37. A composition for feeding animals comprising:
a biosolids mass produced in wastewater treatment; and,
a dietary component selected from the group consisting of proteins, lipids, carbohydrates, vitamins, minerals, and fiber,
wherein said composition has a specific gravity less than 1, whereby said composition floats when added to water, thereby facilitating the uptake of said composition by fish living in said water.
